(19) United States
(12) Patent Application Publication
(10) Pub. No.: US 2006/0110186 A1
(43) Pub. Date: May 25, 2006

(54) Liquid development unit

(75) Inventor: Atsuto Hirai, Ikoma-shi (JP)

Correspondence Address: BRINKS HOFER GILSON & LIONE, P.O. BOX 10395, CHICAGO, IL, 60610, US

(73) Assignee: KONICA MINOLTA BUSINESS TECHNOLOGIES, INC.

(21) Appl. No.: 11/273,856

(22) Filed: Nov. 15, 2005

(30) Foreign Application Priority Data
Nov. 24, 2004 (JP) 2004-338314

(51) Int. Cl. G03G 15/10

(52) U.S. Cl. 399/237

(57) ABSTRACT

A liquid development unit for developing an electrostatic latent image formed on an image carrier, comprises: a liquid developer comprising an insulative liquid containing therein a toner and an additive; a developer carrier for transporting the liquid developer to a development region opposite the image carrier; a feeder for supplying the liquid developer to the developer carrier as forming the liquid developer into a thin film; and a charger for charging the supplied liquid developer in the form of thin film over the developer carrier prior to delivery to the development region opposite the image carrier, wherein the liquid developer contains free additive unattached to the toner in an amount of 0.1 wt % or less based on the insulative liquid.

### RELATED APPLICATION

This application is based on application No.338314/2004 filed in Japan, the contents of which are hereby incorporated by reference.

### BACKGROUND OF THE INVENTION

1. Field of the Invention

The present invention relates to a liquid development unit for use in image forming apparatuses such as copiers and printers, the development unit developing an electrostatic latent image formed on an image carrier by using a liquid developer comprising an insulative liquid containing therein a toner and additives, such as dispersion stabilizer, charge control agent and the like. More particularly, the invention is characterized by preventing the additives except for the toner from eliminating an electric charge of the electrostatic latent image formed on the image carrier.

2. Description of the Related Art

According to the image forming apparatuses such as copiers and printers, an image is generally obtained by: forming an electrostatic latent image on the image carrier, such as a photosensitive member, in correspondence to image information; developing the electrostatic latent image by supplying a toner thereto by means of a development unit; transferring the developed toner image onto a recording medium such as a recording sheet; and fixing the toner image to the recording medium.

As the development unit for developing the electrostatic latent image by supplying the toner thereto as described above, there are known a dry development unit employing a powdery developer comprising a toner or a mixture of toner and carrier, and a liquid development unit employing a liquid developer comprising an insulative liquid containing therein a toner and additives, such as dispersion stabilizer, charge control agent and the like.

In the case of the dry development unit employing the powdery developer, the toner cannot be formed in micro-particles because of fear that such fine particles may be scattered and suspended in the ambient atmosphere. Hence, the toner having an average particle size on the order of 5 to 10 μm is normally employed. This makes it difficult to obtain ultra-fine, high-resolution images.

On the other hand, the following advantages are offered by the liquid development unit employing the liquid developer wherein the toner is dispersed in the insulative liquid admixed with the additives such as dispersion stabilizer and charge control agent. The liquid developer involves no fear of toner scatter in the air so that the toner may be formed in micro particles. Thus, the liquid developer provides high-resolution images excellent in tone characteristics.

The following device has been proposed as such a liquid development unit (see Japanese Unexamined Patent Publication No.H10-319725). In this liquid development unit, the aforesaid liquid developer is formed into a thin film and transported to a development region opposite the image carrier by means of a developer carrier. In the meantime, the liquid developer in the form of thin film is charged for development of the electrostatic latent image formed on the image carrier.

However, the aforementioned liquid development unit has the following drawback. In the liquid developer, some of the additives, such as the dispersion stabilizer and charge control agent, are in a free state or unattached to the toner. Therefore, when the liquid developer is charged as described above, such free additives besides the toner are also charged. The free additives so charged are supplied to an area of the electrostatic latent image formed on the image carrier so as to consume the electric charge of the electrostatic latent image. This interferes with toner adhesion to the electrostatic latent image, disabling the formation of an image having a sufficient image density.

More recently, there are demands for downsizing the apparatus and for high speed image formation. This leads to a requirement of reducing development time by increasing migration speed of the toner in the liquid developer.

In order to increase the migration speed of the toner in the liquid developer as described above, the toner must be increased in charge quantity. It is therefore a general practice to admix an increased amount of additive such as the charge control agent in the liquid developer for increasing the amount of additive, such as the charge control agent, attached to the toner, thereby achieving the increased charge quantity of the toner.

Unfortunately, if the increased amount of additive such as the charge control agent is admixed in the liquid developer, the amount of free additive in the liquid developer is also increased. Accordingly, the above free additive consumes more electric charge of the electrostatic latent image, disabling the formation of the image having the sufficient image density.

### SUMMARY OF THE INVENTION

The invention is directed to a solution to the aforementioned problem encountered in the liquid development unit for developing the electrostatic latent image formed on the image carrier by using the liquid developer comprising the insulative liquid containing therein the toner and the additives, such as dispersion stabilizer and charge control agent.

Specifically, the invention has an object to improve the above liquid development unit by preventing the electric charge of the electrostatic latent image formed on the image carrier from being eliminated by the additive other than the toner, thereby ensuring that the image forming apparatus forms an image having a sufficient image density even in cases where the apparatus is downsized or adapted for high-speed image formation.

A first liquid development unit for developing an electrostatic latent image formed on an image carrier, comprises: a liquid developer comprising an insulative liquid containing therein a toner and an additive; a developer carrier for transporting the liquid developer to a development region opposite the image carrier; a feeder for supplying the liquid developer to the developer carrier as forming the liquid developer into a thin film; and a charger for charging the supplied liquid developer in the form of thin film over the developer carrier prior to delivery to the development region opposite the image carrier, wherein the liquid developer contains free additive unattached to the toner in an amount of 0.1 wt % or less based on the insulative liquid.

According to the first liquid development unit, it is more preferred to use a liquid developer containing the free additive unattached to the toner in an amount of 0.08 wt % or less based on the insulative liquid, or even more preferably in an amount of 0.05 wt % or less based on the insulative liquid.

A second liquid development unit for developing an electrostatic latent image formed on an image carrier, comprises: a liquid developer comprising an insulative liquid containing therein a toner and an additive; a developer carrier for transporting the liquid developer to a development region opposite the image carrier; a feeder for supplying the liquid developer to the developer carrier as forming the liquid developer into a thin film; and a charger for charging the supplied liquid developer in the form of thin film over the developer carrier prior to delivery to the development region opposite the image carrier, wherein the toner contained in the liquid developer eliminates the electric charge of the electrostatic latent image formed on the image carrier by a charge elimination percentage of 90% or more.

According to the second liquid development unit, it is more preferred that the toner contained in the liquid developer eliminates the electric charge of the electrostatic latent image by a charge elimination percentage of 95% or more.

If the charger is interposed in a transport path for the developer carrier to transport the liquid developer in the form of thin film to the development region opposite the image carrier, while the liquid developer is charged by the charger, as suggested by the first and second liquid development units, the liquid developer used for development may be efficiently and adequately charged.

If the liquid developer containing the free additive unattached to the toner in an amount of 0.1 wt % or less based on the insulative liquid is used, as suggested by the first liquid development unit, the charged additive as liberated from the toner is present in a smaller amount, so that a smaller amount of free, charged additive is supplied to the area of the electrostatic latent image formed on the image carrier. Hence, the electric charge of the electrostatic latent image is less consumed by the additive, so that the toner may eliminate the electric charge of the electrostatic latent image by an increased charge elimination percentage. Accordingly, the toner contained in the liquid developer may eliminate the electric charge of the electrostatic latent image by a charge elimination percentage of 90% or more, as suggested by the second liquid development unit.

As a result, even in cases where the image forming apparatus is downsized or is adapted for high-speed image formation, the first and second liquid development units are capable of offering the image having a sufficient image density and of performing a reliable image development even at low potentials.

These and other objects, advantages and features of the invention will become apparent from the following description thereof taken in conjunction with the accompanying drawings which illustrate specific embodiment of the invention.

### BRIEF DESCRIPTION OF THE DRAWINGS

FIG. 1 is a schematic diagram illustrating an image forming apparatus employing a liquid development unit according to one embodiment of the invention; and

FIG. 2 is a schematic diagram illustrating a test apparatus used in an exemplary experiment, examples and comparative examples of the invention for determination of the percentage of potential decrease of electrostatic latent image.

### DESCRIPTION OF THE PREFERRED EMBODIMENT

An image forming apparatus employing a liquid development unit according to an embodiment of the invention will hereinbelow be described in details with reference to the accompanying drawings. It is to be noted that the liquid development unit according to the invention is not limited to the following embodiments and may be embodied with proper modifications made thereto so long as such modifications do not depart from the scope of the invention.

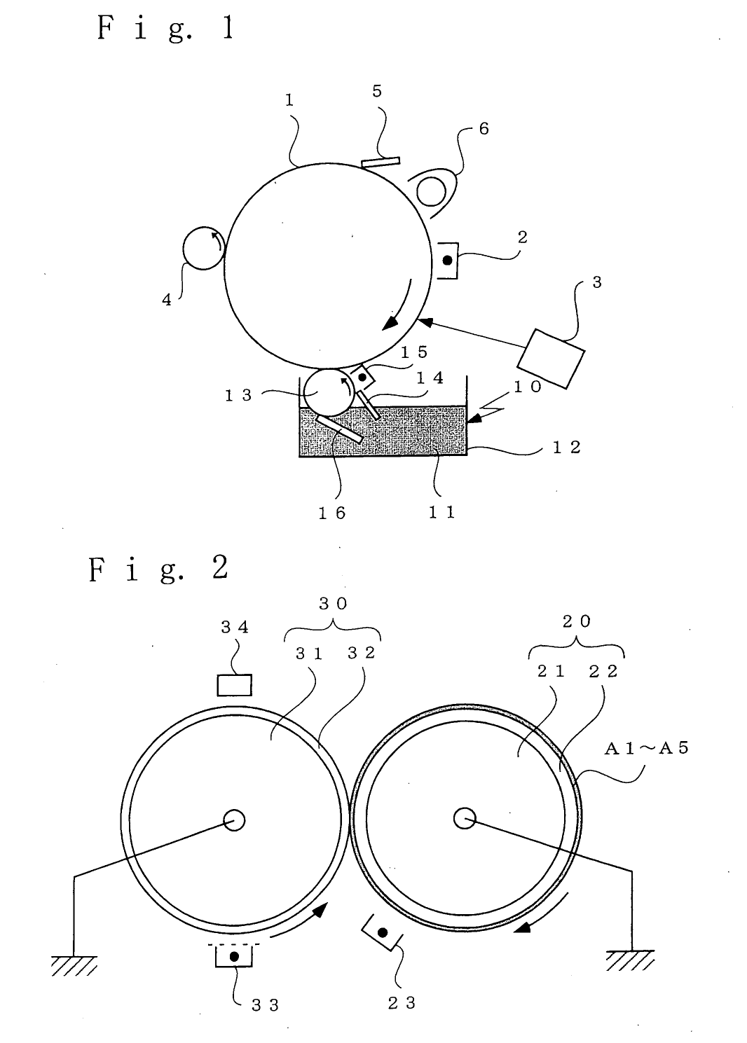

In the image forming apparatus employing the liquid development unit according to the embodiment, as shown in FIG. 1, an image carrier 1 comprising a photosensitive drum is rotated while a surface of the image carrier 1 is electrically charged by a charger 2. Subsequently, an exposure unit 3 irradiates light on the charged surface of the image carrier 1 according to image information, thereby forming on the image carrier 1 an electrostatic latent image corresponding to the image information.

Then, a liquid development unit 10 performs a development process by supplying toner contained in a liquid developer 11 onto the surface of the image carrier 1 on which the electrostatic latent image is formed. Thus, a toner image corresponding to the electrostatic latent image is formed on the surface of the image carrier 1.

Next, the toner image thus formed on the surface of the image carrier 1 is transported to position opposite a transfer unit 4, while a recording medium such as a recording sheet (not shown) is guided into space between the transfer unit 4 and the image carrier 1. The toner image formed on the image carrier 1 is transferred onto the recording medium by means of the transfer unit 4. Subsequently, the toner image so transferred is fixed to the recording medium by means of a fixing unit (not shown) and image formation on the recording medium is accomplished.

After image transfer, the image carrier 1 is removed of the toner remaining on its surface by means of a cleaning member 5 and then, is subjected to a static eliminator 6 for elimination of residual potential on the surface thereof. Thus, the image carrier is ready to perform the subsequent image formation.

In the liquid development unit 10 of the embodiment, the liquid developer 11 including an insulative liquid containing therein the toner and additives, such as a dispersion stabilizer and charge control agent, is stored in a developer reservoir 12, whereas a developer carrier 13 comprising a developing roller is partially dipped in the liquid developer 11. The developer carrier 13 is rotated so as to retain the above liquid developer 11 on its surface for transporting the liquid developer to a development region opposite the image carrier 1.

A regulator member 11 and a charger 15 are interposed in a transport path for the developer carrier to transport the liquid developer 11 to the development region as retaining the liquid developer on its surface. The regulator member 14 regulates the amount of liquid developer 11 carried on the surface of the developer carrier 13 for forming the liquid developer 11 into a thin film carried on the surface of the developer carrier 13. Furthermore, the liquid developer 11 thus formed into the thin film is charged by the above charger 15.

Next, the charged liquid developer 11 in the form of thin film is delivered to the development region opposite the image carrier 1 as retained on the surface of the developer carrier 13, so that the development process is carried out by supplying the charged toner in the liquid developer 11 to the surface of the image carrier 1 with the electrostatic latent image formed thereon.

After the development process is performed in this manner, the liquid developer 11 remaining on the surface of the developer carrier 13 is brought into the developer reservoir 12, where the liquid developer 11 remaining on the surface of the developer carrier 13 is separated from the developer carrier 13 by a cleaning member 16 so as to be returned into the developer reservoir 12.

In the liquid development unit 10 of the embodiment, the above liquid developer 11 may contain 0.1 wt % or less of free additives unattached to the toner based on the insulative liquid.

The following advantage may be obtained by using the liquid developer 11 wherein the amount of free additives unattached to the toner is 0.1 wt % or less based on the insulated liquid. When the liquid developer 11 in the form of thin film over the developer carrier 13 is charged by means of the charger and is delivered to the development region opposite the image carrier 1 for developing the electrostatic latent image formed on the image carrier 1, the electric charge of the electrostatic latent image formed on the image carrier 1 is less eliminated by the charged additives liberated from the toner which adhere to an area of the electrostatic latent image. Hence, the charged toner is smoothly supplied to the area of the electrostatic latent image, so that a sufficient amount of toner is supplied to the electrostatic latent image. Thus is formed an image having a sufficient image density.

The above liquid developer 11 containing the free additives unattached to the toner in the amount of 0.1 wt % or less based on the insulative liquid may be prepared as follows. Toner particles ground to some particle sizes are dispersed in the insulative liquid wherein the concentration of the additives such as a dispersant is adjusted to 0.1 wt % or less. The above toner particles are further pulverized to a predetermined particle size while the above additives are made to adhere to the toner particles.

An alternative procedure may be adopted. Toner particles ground to some particle sizes are dispersed in an insulative liquid containing the additives such as a dispersant in high concentrations. The above toner particles are further pulverized to a predetermined particle size while the above additives are made to adhere to the toner particles. The resultant toner particles with the additives attached thereto are separated from the insulative liquid containing the additives such as the dispersant in high concentrations. The toner particles thus separated are dispersed in an insulative liquid so as to reduce the amount of free additives present in the liquid. In the process wherein the toner particles ground to some particle sizes are dispersed in the insulative liquid containing the additives such as the dispersant in high concentrations, the toner particles may be quickly and properly dispersed. If the dispersed toner particles with the additives attached thereto are separated from the dispersion and then, the separated toner particles are dispersed in the insulative liquid, it is easy to adjust the amount of free additives unattached to the toner particles to 0.1 wt % or less based on the insulative liquid.

The lower limit of the amount of free additives unattached to the toner particles is not particularly limited. If the amount of such free additives is limited to a very small value, it becomes difficult to prepare a desired dispersion. What is more, any further effect may not be obtained by excessively reducing the amount of free additives. It is therefore favorable that the free additives are contained in concentrations of 0.05 wt % or more.

Any liquid having properties of high electrical insulation, low flammability, low odor emission and the like may be used in the above liquid developer 11. Examples of a usable insulative liquid include aliphatic hydrocarbon, alicyclic hydrocarbon, aromatic hydrocarbon, halogenated hydrocarbon, polysiloxane and the like. Above all, liquid paraffin and silicone oil may more preferably be used.

Usable as the toner are colored resin particles containing a colorant such as a pigment and a binder resin. The colored resin particles may preferably have a volume-average particle size of 0.1 μm to 5 μm. The above liquid developer 11 may preferably contain the toner in concentrations of 10 to 40 mass %.

Furthermore, the above liquid developer 11 may preferably have a viscosity of 0.2 Pa·s to 10000 Pa·s (25° C.). The reason is that if the viscosity of the liquid developer 11 is too low, the liquid developer 11 may not be adequately delivered to the development region opposite the image carrier 1 and that if the viscosity of the liquid developer 11 is too high, development speed is slowed down.

Examples of a usable dispersant in the above liquid developer 11 include rubber-base resins, long-chain alkyl containing acrylic resins, alkyl-modified polyvinylpyrrolidones, hydrogenated rosin esters, modified alkyd resins, polyester resins and a variety of surfactants.

### EXEMPLARY EXPERIMENT

Next, an experiment was conducted to examine how the electrostatic latent image formed on the image carrier was affected by the free additive, which was contained in the insulative liquid in varied amounts.

In this experiment, MORESCO WHITE P-120 (commercially available from Matsumura Oil Research Corp.) was used as the insulative liquid composed of aliphatic hydrocarbon, whereas Solsperse 13940 (a dispersant commercially available from AVECIA LTD.) was used as the additive composed of polyester resins. Six types of liquid samples A1 to A6 were prepared by admixing different amounts of additive in the above insulative liquid. The liquid samples contained the additive in concentrations of 1 wt % to 0.01 wt %.

This experiment used the following devices shown in FIG. 2, as a test apparatus. The apparatus included a developer carrier roller 20 including an aluminum drum 21 having a diameter of 100 mm and formed with a conductive rubber layer 22 on its surface. The conductive rubber layer was formed from NBR in a thickness of 5 mm. The developer carrier roller 20 was opposed by an insulation roller 30 including an aluminum drum 31 having a diameter of 100 mm and formed with an insulative layer 32 on its surface. The insulative layer was formed from PET. The developer carrier roller 20 and the insulation roller 30 were both grounded. The developer carrier roller 20 and the insulation roller 30 were rotated in the same direction with respect to a region at which these rollers opposed each other. The developer carrier roller 20 and the insulation roller 30 were each rotated at a circumferential speed of 200 mm/sec.

Each of the above liquid samples A1 to A6 was applied to a surface of the developer carrier roller 20 in a thickness of about 7 μm. A scorotron charger 23 having an aperture size of 90 mm was disposed on an upstream side of a path in which the each of the liquid samples A1 to A6 was transported to the insulation roller 30. The charger exposed each of the liquid samples A1 to A6 to a +10 μA current for electrically charging the liquid sample. On the other hand, an electrostatic latent image of −300V was formed on a surface of the insulation roller 30 by means of a scorotron charger 33.

Then, each of the liquid samples A1 to A6 thus charged was brought into contact with the surface of the insulation roller 30 with the electrostatic latent image of −300V formed thereon. Subsequently, measurement was taken on the potential Va of the surface of the insulation roller 30 by means of a surface potentiometer 34 (MODEL 304 commercially available from Trek Japan Corp.). Each electrostatic image after contact with each of the liquid samples A1 to A6 was determined for the percentage of potential decrease based on the following equation:
Potential decrease percentage(%)=[(Vo−Va)/Vo]×100
(wherein Vo denotes a potential of the electrostatic latent image formed on the surface of the insulation roller 30 by means of a scorotron charger 33)

The results are listed in the following table 1.

TABLE 1

| | Dispersant concentration | Percentage of potential |
|---|---|---|
| Liquid | in insulative liquid | decrease of latent image |
| sample | (wt %) | (%) |
| A1 | 1 | 57.1 |
| A2 | 0.5 | 47.3 |
| A3 | 0.1 | 19.3 |
| A4 | 0.08 | 4.9 |
| A5 | 0.05 | 1.0 |
| A6 | 0.01 | 0.0 |

The results show that in the cases of the liquid samples A3 to A6 wherein the above additive is added to the insulative liquid in concentrations of 0.1 wt % or less, the electrostatic latent images are notably decreased in the percentage of potential decrease, as compared with the cases of the liquid samples A1, A2 wherein the above additive is added to the insulative liquid in concentrations of more than 0.1 wt %. That is, the liquid samples A3 to A6 suppress the potential decrease of the electrostatic latent image due to the free additive. In the cases of the liquid samples A4 to A6 containing the additive in concentrations Of 0.08 wt % or less, in particular, the electrostatic latent images are further decreased in the percentage of potential decrease. In the cases of the liquid samples A5, A6 containing the additive in concentrations Of 0.05 wt % or less, the electrostatic latent images have extremely low percentages of potential decrease. These liquid samples even further reduce the potential decrease of the electrostatic latent image due to the free additive.

Next, liquid developers for use in Examples 1 to 3 and a liquid developer for use in Comparative Example 1 were prepared. The resultant liquid developers were subjected to an experiment to determine the respective percentages of potential decrease of electrostatic latent images.

### Example 1

In Example 1, the liquid developer was prepared as follows. 100 parts by weight of thermoplastic polyester resin (softening point of 121° C., glass transition point of 67° C.), 20 parts by weight of copper phthalocyanine blue-base cyan pigment (C.I. Pigment Blue 15:1), and 5 parts by weight of zinc salicylate complex (a negative-charge control agent commercially available as Vontron E-84 from Orient Industry Cp., Ltd.) were fully blended together by means of Henschel mixer. The resultant mixture was kneaded by a twin-screw extruder and the kneaded product was cooled.

The kneaded product thus cooled was roughly ground by a cutter mill and then was pulverized by means of a jet mill (commercially available from Japan Pneumatic Mfg. Co., Ltd.). Thus was obtained colored toner grit having a volume-average particle size on the order of 10 μm.

Next, 30 parts by weight of the above colored toner grit was admixed in 70 parts by weight of dispersant solution containing 0.05 wt % of dispersant composed of polyester resins (Solsperse 13940 commercially available from AVECIA LTD.) as an additive in an insulative liquid composed of aliphatic hydrocarbon (MORESCO WHITE P-120 commercially available from Matsumura Oil Research Corp.). The resultant solution mixture was charged in a ⅛-gallon vessel equipped with water jacket of a sand grinder (commercially available from IGARASHI KIKAI SEIZO CO., Ltd.) using 150 cc of glass beads having a diameter of 1 mm as a grinding medium. The solution mixture was subjected to a 15-hour wet grinding process under conditions of cooling water temperature at 20° C. and disk rotational speed of 2000 rpm. Thus was obtained a stock solution of liquid developer, in which a toner having a volume-average particle size of 3.66 μm was dispersed. The volume-average particle size of the toner was determined using a laser-refraction particle size distribution analyzer (SALD-2200 commercially available from SHIMADZU CORPORATION).

The liquid developer was prepared by diluting the stock solution of liquid developer with the aforesaid insulative liquid (MORESCO WHITE P-120 commercially available from Matsumura Oil Research Corp.) until solids of the stock solution of liquid developer are present in an amount of 20 wt % of the liquid developer. When a viscosity of the liquid developer is measured by means of a viscosity measurement device (ARES FR-100 commercially available from ARES Corp.) at environmental temperature of 25° C., the viscosity was 5.34 Pa·s.

### Example 2

In Example 2, the liquid developer was prepared as follows. A dispersant solution was added to the stock solution of liquid developer prepared the same way as in Example 1. The dispersant solution contained 0.05 wt % of dispersant, as the additive, (Solsperse 13940 commercially available from AVECIA LTD.) in the above insulative liquid (MORESCO WHITE P-120 commercially available from Matsumura Oil Research Corp.). The liquid developer was obtained by adjusting the amount of the solids in the stock solution of liquid developer to 20 wt %. When measured by the same way used in Example 1, a viscosity of the liquid developer was 5.21 Pa·s.

### Example 3

In Example 3, the liquid developer was prepared as follows. The same procedure as in Example 1 was taken to prepare the colored toner grit. Subsequently, 30 parts by weight of the above colored toner grit was added to 70 parts by weight of dispersant solution containing 2 wt % of dispersant, as the additive, (Solsperse 13940 commercially available from AVECIA LTD.) in the above insulative liquid (MORESCO WHITE P-120 commercially available from Matsumura Oil Research Corp.). The resultant solution mixture was subjected to the 15-hour wet grinding process just as in Example 1, thereby giving a first stock solution of liquid developer wherein a toner having a volume-average particle size of 3.59 μm was dispersed.

The first stock solution of liquid developer was charged in a centrifuge (H-9R commercially available from KOKUSAN CO., LTD.) which was operated at 15000 rpm for 10 minutes for separating the stock solution into solids and liquid. The solids were filtered off. A second stock solution of liquid developer was prepared by adding the solids to the aforesaid insulative liquid (MORESCO WHITE P-120 commercially available from Matsumura Oil Research Corp.) in a manner to provide a solids concentration of 20 wt %.

Subsequently, the second stock solution of liquid developer was separated into solids and liquid by means of the centrifuge (H-9R commercially available from KOKUSAN CO., LTD.) in the aforementioned manner. The solids were filtered off. The liquid developer was prepared by adding the solids to the aforesaid insulative liquid (MORESCO WHITE P-120 commercially available from Matsumura Oil Research Corp.) in a manner to provide a solids concentration of 20 wt %. When measured by the same way used in Example 1, a viscosity of the liquid developer was 5.01 Pa·s.

### Comparative Example 1

The liquid developer of Comparative Example 1 was prepared as follows. The same procedure as in Example 3 was taken to prepare the first stock solution of liquid developer. The insulative liquid (MORESCO WHITE P-120 commercially available from Matsumura Oil Research Corp.) was added to the first stock solution of liquid developer in a manner to provide a solid concentration of 20 wt %. When measured by the same way used in Example 1, a viscosity of the liquid developer was 3.51 Pa·s.

Each of the liquid developers prepared in Examples 1 to 3 and Comparative Example 1 was charged in the centrifuge (H-9R commercially available from KOKUSAN CO., LTD.) which was operated at 15000 rpm for 10 minutes for separating the liquid developer into solids and liquid. A liquid component thus obtained was determined for the amount of free additive based on the above insulative liquid. The results are listed in Table 2.

Furthermore, the liquid component so obtained from each of the liquid developers of Examples 1 to 3 and Comparative Example 1 was determined for the percentage of potential decrease of electrostatic latent image the same way as in the foregoing liquid samples A1 to A6. The results are listed in the following Table 2.

TABLE 2

| | Dispersant concentration | |
|---|---|---|
| | in insulative liquid | Percentage of potential |
| | (wt %) | decrease of latent image (%) |
| Example 1 | 0.005 | 1.9 |
| Example 2 | 0.03 | 1.7 |
| Example 3 | 0.07 | 3.8 |
| Comparative | 0.43 | 41.0 |
| example 1 | | |

The results show that the liquid developers of Examples 1 to 3 containing the additive in concentrations of 0.1 wt % or less based on the insulative liquid achieve notably decrease in the percentage of potential decrease of electrostatic latent image, as compared with the liquid developer of Comparative Example 1 containing the additive in concentrations of more than 0.1 wt % based on the insulative liquid. Thus, the liquid developers of Examples 1 to 3 suppress the potential decrease of the electrostatic latent image due to the free additive. The liquid developers of Examples 1, 2 containing the additive in concentrations of 0.05 wt % or less, in particular, dramatically reduce the percentage of potential decrease of electrostatic latent image. Thus, the potential decrease of the latent image due to the free additive is suppressed even further.

Although the present invention has been fully described by way of examples, it is to be noted that various changes and modification will be apparent to those skilled in the art.

Therefore, unless otherwise such changes and modifications depart from the scope of the present invention, they should be construed as being included therein.

1. A liquid development unit for developing an electrostatic latent image formed on an image carrier, comprising:
a liquid developer comprising an insulative liquid containing therein a toner and an additive;
a developer carrier for transporting the liquid developer to a development region opposite the image carrier;
a feeder for supplying the liquid developer to the developer carrier as forming the liquid developer into a thin film; and
a charger for charging the supplied liquid developer in the form of thin film over the developer carrier prior to delivery to the development region opposite the image carrier,
wherein the liquid developer contains free additive unattached to the toner in an amount of 0.1 wt % or less based on the insulative liquid.

2. A liquid development unit according to claim 1, wherein the liquid developer contains the free additive unattached to the toner in an amount of 0.08 wt % or less based on the insulative liquid.

3. A liquid development unit according to claim 1, wherein the liquid developer contains the free additive unattached to the toner in an amount of 0.05 wt % or less based on the insulative liquid.

4. A liquid development unit according to claim 1, wherein the insulative liquid used in the liquid developer is at least one selected from the group consisting of silicone oil, aliphatic hydrocarbon, alicyclic hydrocarbon, aromatic hydrocarbon, halogenated hydrocarbon and polysiloxane.

5. A liquid development unit according to claim 1, wherein the toner used in the liquid developer has a volume-average particle size in the range of 0.1 μm to 5 μm.

6. A liquid development unit according to claim 1, wherein the liquid developer has toner concentration in the range of 10 to 40 mass %.

7. A liquid development unit according to claim 1, wherein the liquid developer has viscosity at 25° C. in the range of 0.2 Pa·s to 10000 Pa·s.

8. A liquid development unit according to claim 1, wherein at least one dispersant selected from the group consisting of rubber resins, long-chain alkyl containing acrylic resins, alkyl-modified polyvinylpyrrolidones, hydrogenated rosin esters, modified alkyd resins, polyester resins and surfactants is added as the additive in the liquid developer.

9. A liquid development unit for developing an electrostatic latent image formed on an image carrier, comprising:
a liquid developer comprising an insulative liquid containing therein a toner and an additive;
a developer carrier for transporting the liquid developer to a development region opposite the image carrier;
a feeder for supplying the liquid developer to the developer carrier as forming the liquid developer into a thin film; and
a charger for charging the supplied liquid developer in the form of thin film over the developer carrier prior to delivery to the development region opposite the image carrier,
wherein the toner contained in the liquid developer eliminates the electric charge of the electrostatic latent image formed on the image carrier by a charge elimination percentage of 90% or more.

10. A liquid development unit according to claim 9, wherein the toner contained in the liquid developer eliminates the electric charge of the electrostatic latent image formed on the image carrier by a charge elimination percentage of 95% or more.

11. A liquid development unit according to claim 9, wherein the liquid developer contains free additive unattached to the toner in an amount of 0.1 wt % or less based on the insulative liquid.

12. A liquid development unit according to claim 9, wherein the insulative liquid used in the liquid developer is at least one selected from the group consisting of silicone oil, aliphatic hydrocarbon, alicyclic hydrocarbon, aromatic hydrocarbon, halogenated hydrocarbon and polysiloxane.

13. A liquid development unit according to claim 9, wherein the toner used in the liquid developer has a volume-average particle size in the range of 0.1 μm to 5 μm.

14. A liquid development unit according to claim 9, wherein the liquid developer has toner concentration in the range of 10 to 40 mass %.

15. A liquid development unit according to claim 9, wherein the liquid developer has viscosity at 25° C. in the range of 0.2 Pa·s to 10000 Pa·s.

16. A liquid development unit according to claim 9, wherein at least one dispersant selected from the group consisting of rubber resins, long-chain alkyl containing acrylic resins, alkyl-modified polyvinylpyrrolidones, hydrogenated rosin esters, modified alkyd resins, polyester resins and surfactants is added as the additive in the liquid developer.

17. A liquid development unit according to claim 9, wherein the liquid developer contains free additive unattached to the toner in an amount of 0.1 wt % or less based on the insulative liquid.
